(19) United States
(12) Patent Application Publication
(10) Pub. No.: US 2025/0320236 A1
(43) Pub. Date: Oct. 16, 2025

(54) METAL ORGANIC FRAMEWORKS (MOFs) AND METHODS OF USE

(71) Applicants: David Jonathan Conway, West Palm Beach, FL (US); Kuntal Manna, New Delhi (IN); Chhaya Thadhani, New Delhi (IN); Manav Chauhan, Punjab (IN); Akanksha Choudhary, Uttar Pradesh (IN); Ramya Ahuja, Haryana (IN)

(72) Inventors: David Jonathan Conway, West Palm Beach, FL (US); Kuntal Manna, New Delhi (IN); Chhaya Thadhani, New Delhi (IN); Manav Chauhan, Punjab (IN); Akanksha Choudhary, Uttar Pradesh (IN); Ramya Ahuja, Haryana (IN)

(21) Appl. No.: 18/634,910

(22) Filed: Apr. 13, 2024

(51) Int. Cl. C07F 7/00; C01B 39/00; C09K 11/06

(52) U.S. Cl. CPC C07F 7/003; C01B 39/00; C09K 11/06; C09K 2211/18

(57) ABSTRACT

Aspects of the disclosure relates to articles, compositions, and systems for targeted cargo delivery and release. In some embodiments, the disclosure relates to metal organic frameworks (MOF). The MOFs comprise a plurality of metal clusters and a plurality of ligands that are coordinated with the plurality of metal clusters. In some embodiments, the disclosure relates to the MOFs possessing azobenzene moiety sensitive to hypoxic conditions. In some embodiments, the disclosure relates to one-dimensional coordination polymers being utilized for drug delivery for cancer treatment. While in some embodiments, the disclosure relates to the persistent luminescent phosphors and their photoluminescence behaviour in the presence of oxygen. Lastly, in some embodiments, the disclosure relates to how MOFs have been employed in OLED technology because of their tunable nature, large surface area and their versatile chemistry. Thus, MOFs play an important role in photovoltaic technology and expanding the market for sustainable energy solutions.

### FIELD

The present disclosure generally relates to the photo-responsive metal-organic frameworks (MOFs), photon-up conversion coordination polymers and persistent luminescence materials for drug delivery and release under hypoxia conditions.

### BACKGROUND

Target selectivity is the prime concern for drug development. The compounds or the frameworks possessing azobenzene moiety are sensitive in the presence of light and under hypoxia conditions making them suitable for targeted cargo delivery. The cleavage of azobenzene induces the change in the pore size, hydrophobicity and phase separation thereby enhancing the drug uptake, spatio-temporal cargo release and sensitizing the pharmacological effect of the active agent. On the other hand, the coordination polymers having the ability to convert low-energy photons into higher-energy ones (photon-upconversion) can be utilized for cancer treatment under hypoxic conditions, wherein the tumors have decreased oxygen levels. The characteristic property of persistent luminescence or long-lasting luminescence from visible to NIR radiation for hours or days even after the stoppage of external radiation enables the materials/phosphors to act as glow-in-sensors which can be then incorporated into various indicators and further be used in various applications to monitor oxygen levels continuously. Lastly, the integration of MOFs into photovoltaic applications offers potential to address key challenges such as efficiency improvements, stability enhancements and cost reductions.

### SUMMARY

The subject matter of the present disclosure involves, in some cases, interrelated products, alternative solutions to a particular problem, and/or a plurality of different uses of one or more systems and/or articles.

Some aspects of the disclosure relate to the photo-responsive metal-organic frameworks of Formula (I):
[M-AZB]
   wherein:
M is Zr(IV), Al(III), Ti(IV), Fe(III), Ce(IV), Cr(III), Ru(III), La(III), Gd(III) etc.;
AZB is azobenzene dicarboxylate ligand.

In some embodiments, the disclosure relates to one or more methods for using the metal-organic frameworks disclosed herein. In some embodiments, the methods relate to how these metal-organic frameworks can undergo cleavage of azo bond. In some embodiments, the disclosure relates to how in the presence of active reducing agents in the tumor cells, the MOF having azo bonds gets reduced to two amine groups leading to the rupture of the entire structure of the MOF, due to the breakdown of the linker and thus, the drug that is encapsulated inside the 3D structure of the MOF gets released into the cell. In some embodiments, the methods relate to how the photo-responsive frameworks under hypoxia conditions are utilized for targeted cargo delivery purposes via a combination of light-triggered release mechanisms and hypoxia-responsive components. In some embodiments, the disclosure relates to how hypoxia- responsive components can be integrated into the frameworks. These components act as molecular triggers that initiate the process of drug release by reacting to low oxygen levels. In some embodiments, the disclosure relates to the different methods by which the drugs are being encapsulated into the photo-responsive framework, ensuring that the process of encapsulation does not interfere with the responsiveness of the hypoxia-responsive components. In some embodiments, the disclosure related to how the photo-responsive framework can be administered at the target site like tumor where the hypoxia conditions are present. In some embodiments, the disclosure relates to how the hypoxia-responsive components can be activated under hypoxia conditions, thereby resulting in additional drug release in response to low oxygen levels.

Some aspects of the disclosure relate to the coordination of polymers exhibiting multi-photon absorption of the formula (II):

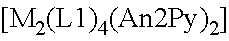

wherein:
M is Zn(II), Ag(I), Hg(II), Fe(II), Fe(III), Cu(I), Cu(II), Mn(II), Cd(II), Ni(II) etc.;
L1 is benzoate, benzenedicarboxylate (bdc), 2-aminoterephthalic acid (bdc-NH₂), isophthalic acid, benzene-1,3,5-tricarboxylic acid (btc) etc.;
An2Py is the 9,10-bis((E)-2-(pyridine-4-yl) anthracene) ligand.

In some embodiments, the disclosure relates to how the photon-up conversion materials can be functionalized into drug delivery systems and can serve as carriers for therapeutic agents, thereby facilitating targeted delivery to tumors. In some embodiments, the disclosure relates to how the process of upconversion can be utilized in order to trigger the process of drug release from different carriers upon NIR irradiation, thereby offering spatial and temporal control over drug delivery.

Other advantages and novel features of the parent disclosure will become apparent from the following detailed description of various non-limiting embodiments of the disclosure when considered in conjunction with the accompanying figures.

### BRIEF DESCRIPTION OF DRAWINGS

Non-limiting embodiments of the present disclosure will be described by way of example with reference to the accompanying figures, which are schematic and are not intended to be drawn to scale. In the figures:

FIG. 1 shows a NMR of the Z1 linker in DMSO solvent, according to some embodiments;

FIG. 2 shows a NMR of the Z2 linker in CDC13 solvent, according to some embodiments;

FIG. 3 shows a HRMS of the Z1 linker in MeOH solvent, according to some embodiments;

FIG. 4 shows a HRMS of the Z2 linker in MeOH solvent, according to some embodiments;

FIG. 5 shows powder x-ray diffraction plot of Y1 MOF, according to some embodiments;

FIG. 6 shows powder x-ray diffraction plot of Y2 coordination polymer, according to some embodiments;

FIG. 7 shows powder x-ray diffraction plots of Y1 MOF at different pH conditions, according to some embodiments;

FIG. 8 shows powder x-ray diffraction plots of Y1 MOF for different time durations in PBS (1x) solvent, according to some embodiments;

FIG. 9 shows powder x-ray diffraction plots of Y1 MOF for different time durations in aqueous medium, according to some embodiments;

FIG. 10 shows powder x-ray diffraction plots of Y1 MOF both being dry and under solvent conditions after 1 month at room temperature and at 37° C., according to some embodiments;

FIG. 11 shows the IR spectra of Y1 MOF and Z1 linker, according to some embodiments;

FIG. 12 shows the IR spectra of Y1 MOF for different pH conditions in acidic media, according to some embodiments;

FIG. 13 shows the IR spectra of Y1 MOF for different pH conditions in alkaline media and at neutral pH conditions, according to some embodiments;

FIG. 14 shows the TGA plot of Y1 MOF, according to some embodiments;

FIG. 15 shows the BET analysis of the Y1 MOF, according to some embodiments;

FIG. 16 shows TEM analysis of Y1 MOF, according to some embodiments;

FIG. 17 shows SEM image of Y1 MOF, according to some embodiments;

FIG. 18 shows an excitation intensity graph of Y2 coordination polymer in dichloromethane (DCM), according to some embodiments;

FIG. 19 shows an emission intensity graph of Y2 coordination polymer in dichloromethane (DCM), according to some embodiments;

FIG. 20 shows a plot of the quantum yield for Y2 coordination polymer, according to some embodiments;

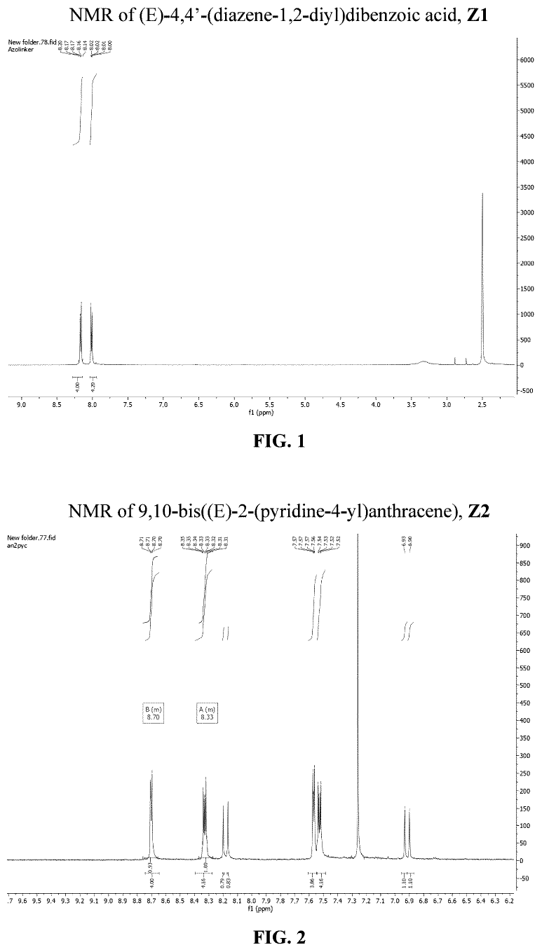

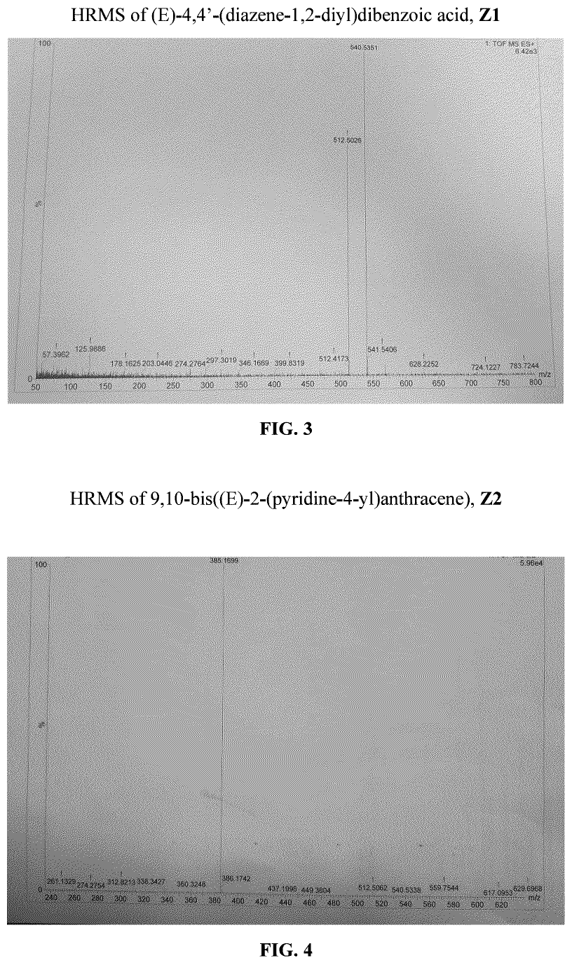

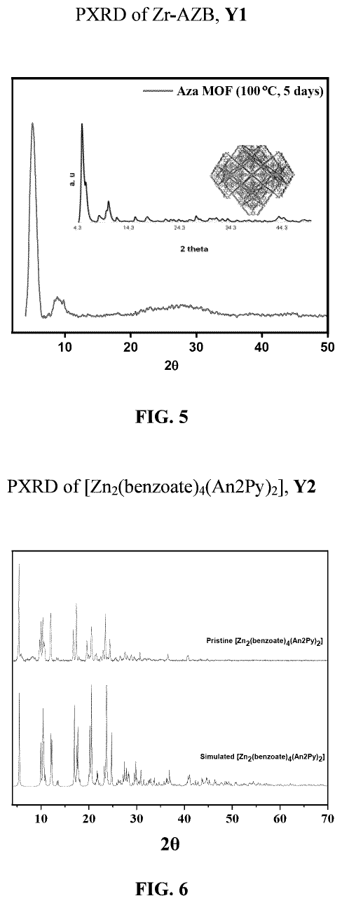

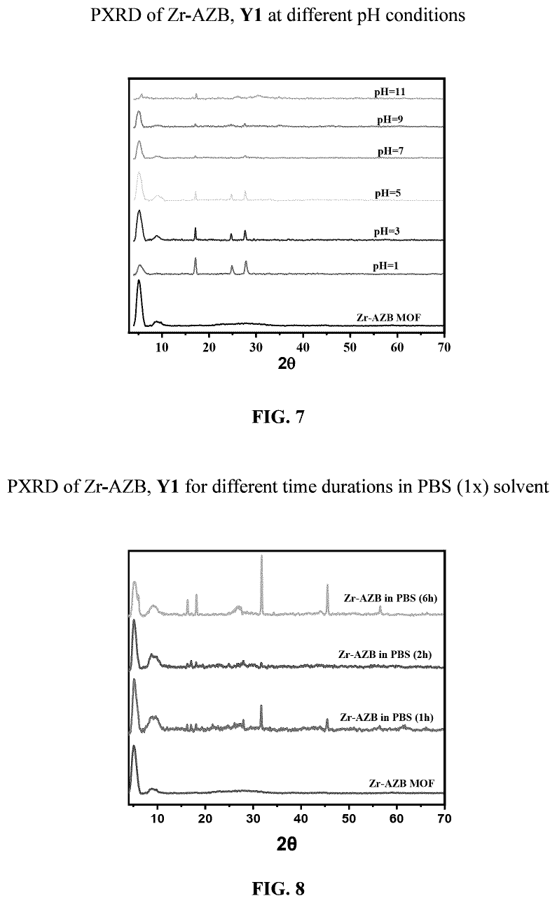

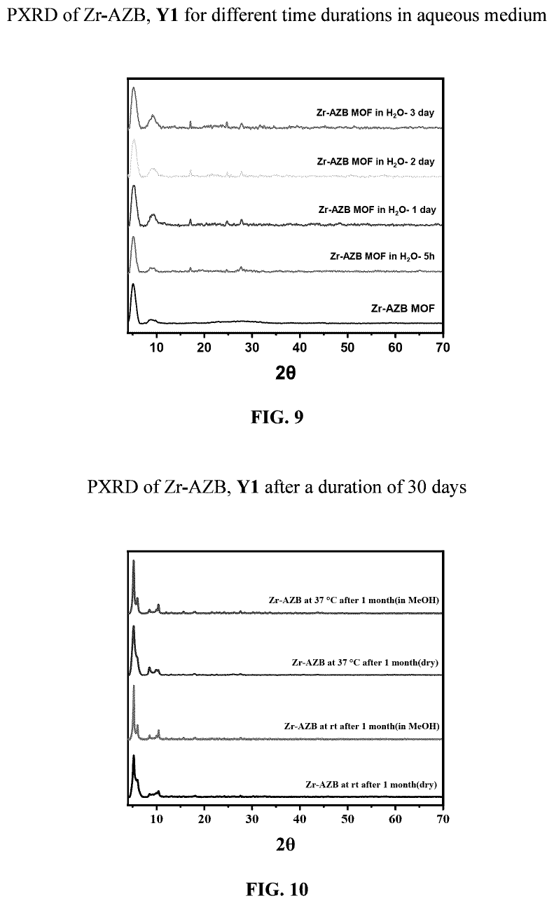

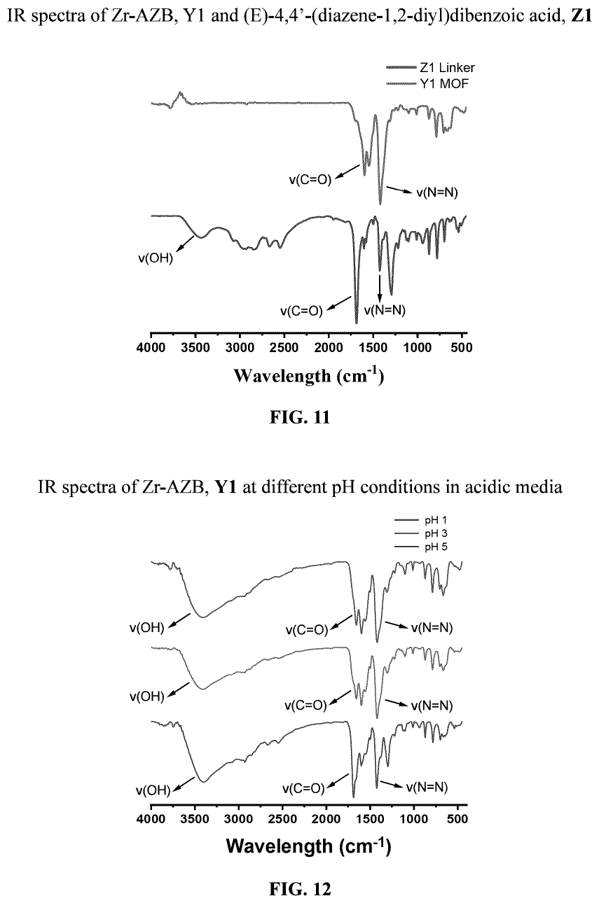

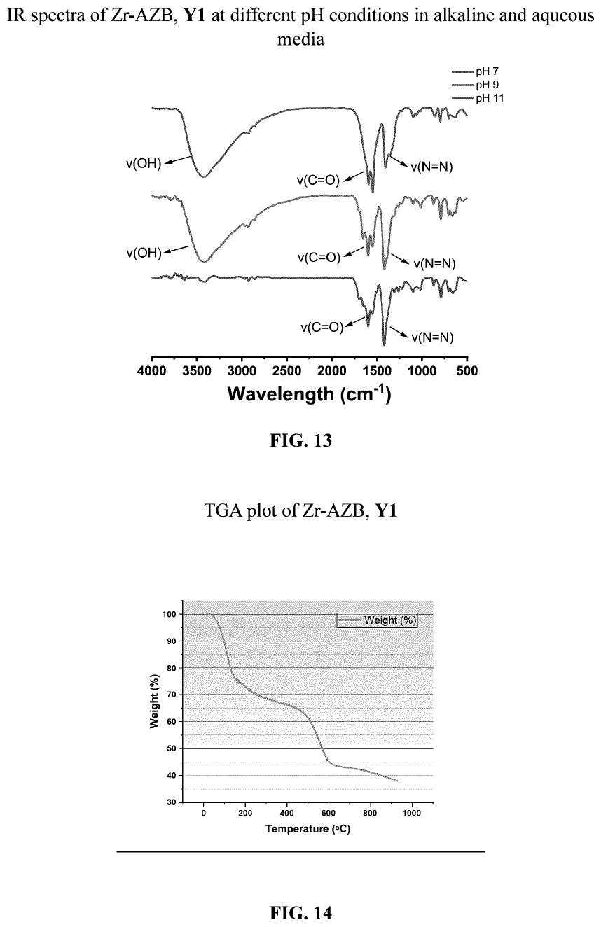

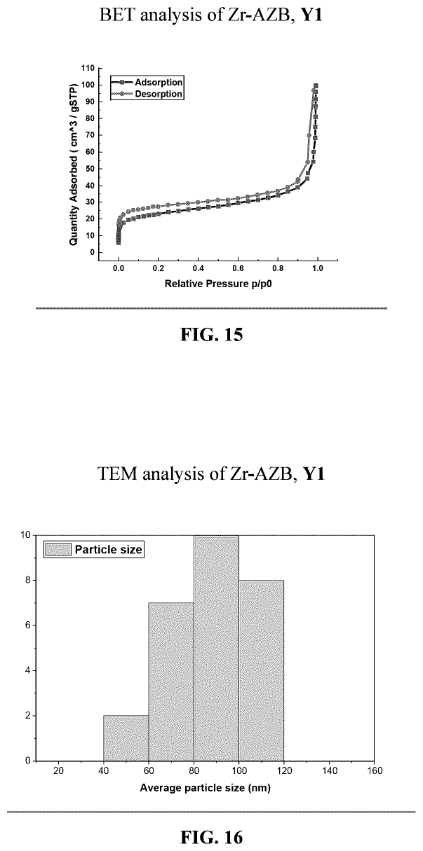

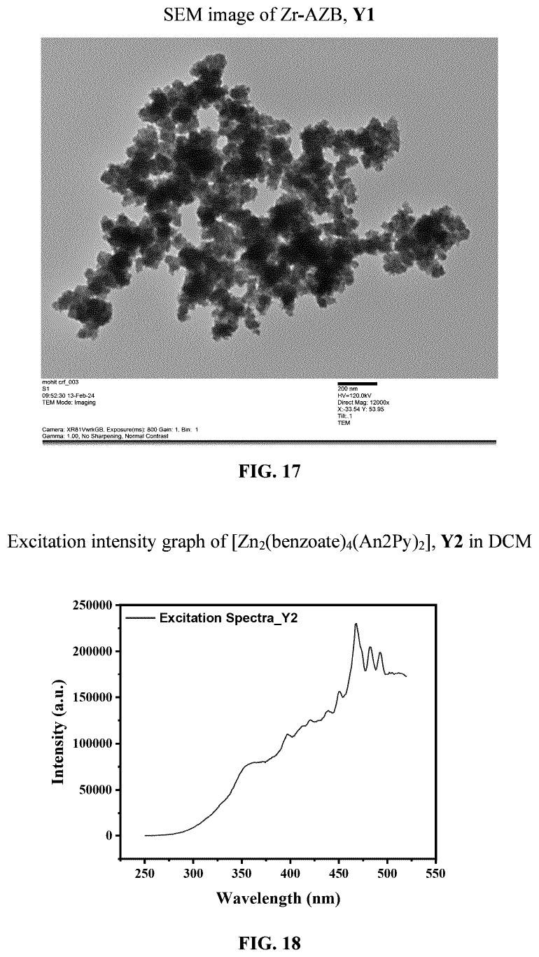

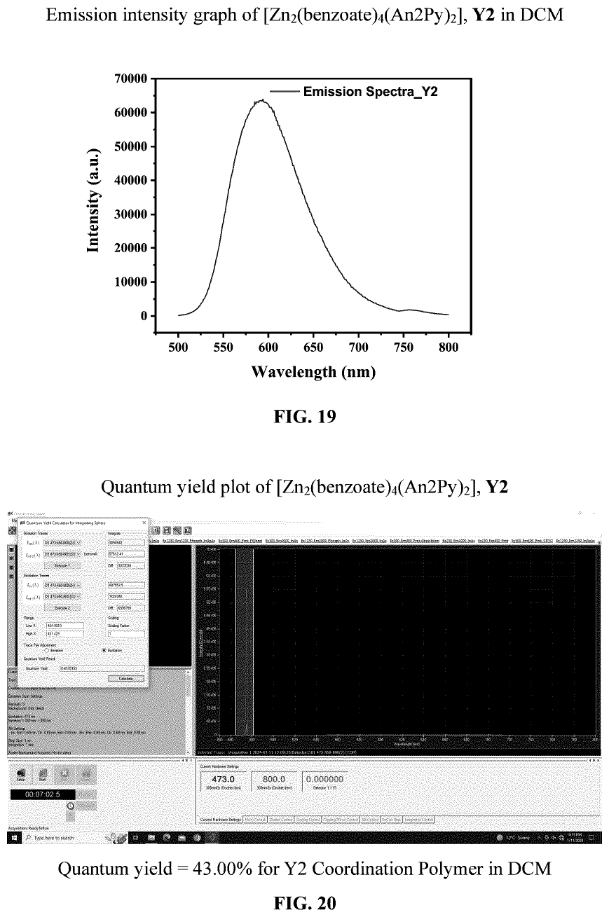

### DETAILED DESCRIPTION

Aspects of the disclosure generally relate to articles, compositions, and systems for drug loading and release under hypoxia conditions. In some embodiments, it is described how metal-organic frameworks are suitable for drug loading. They possess features like tunable pore size, high surface area and are more efficient than the conventional systems used for drug loading—
a) High Surface Area: MOFs being porous in nature allow for a higher drug loading capacity and hence, can carry a significant amount of therapeutic agents.
b) Tunable Pore Size: This property enables controlled release of drugs making them desirable for cancer therapies wherein sustained and targeted drug delivery is required.
c) Versatility: MOFs can be designed to encapsulate different types of drugs, including small molecules and biomolecules.
d) Biocompatibility and Surface Functionalization: The surface of MOFs can be modified with different functional groups to enhance their biocompatibility, thereby improving targeting capabilities, reducing the risks of adverse reactions in the biological system and providing additional functionalities, such as imaging capabilities.
e) pH and Temperature Responsiveness: MOFs also respond to changes in pH or temperature, allowing for stimuli-responsive drug release which is indeed beneficial in cancer therapy, where the microenvironment of tumors often differs from normal tissues.

In some embodiments, the disclosure relates to the ability of photo-responsive metal-organic frameworks (MOFs) undergoing controlled, reversible changes in the presence of light stimuli, thereby making them appropriate for drug delivery and release applications. These photo-responsive MOFs offer several advantages for drug release:
a) By using light as a trigger, drug release can be activated at specific sites and times, thereby allowing for targeted delivery to specific tissues and cells.
b) These MOFs can be designed to respond to various light sources like ultraviolet (UV), visible, near-infrared (NIR). This versatility provides flexibility in choosing the appropriate light stimulus for the desired application.
c) Light-induced changes in the structure of photo-responsive MOFs enable on-demand drug release.
d) These MOFs can be designed to protect drugs during circulation and release them only at the target site. This enhances the stability and bioavailability of the drugs, thereby making them efficient for the desired application.
e) Moreover, the structure of these MOFs can be tailored to encapsulate multiple drugs or therapeutic agents simultaneously.

In some embodiments, the disclosure relates to azobenzene-based metal-organic frameworks characterized by a nitrogen-nitrogen double bond (N═N) especially designed for cancer detection and other treatment systems. In some embodiments, the disclosure relates to the azobenzene frameworks seen to be responsive to changes in the environment such as low oxygen levels (hypoxia). The advantages of using azo-based MOFs for drug loading under hypoxic conditions are:
a) Hypoxia Responsiveness: MOFs having azo bond can undergo reduction reaction in response to hypoxic conditions. This property can be utilized to trigger drug release specifically in the hypoxic tumor microenvironment.
b) Selective Drug Release: The hypoxia-triggered reduction of azo groups within the MOF can lead to the breakdown of the MOF structure or alterations in its properties. This selective response to low oxygen levels allows for controlled and targeted drug release in tumor tissues, minimizing exposure to healthy tissues.
c) Improved Tumor Detection: The ability of azo-based MOFs to release drugs in response to hypoxia also aid in overcoming challenges related to tumor penetration. This can be particularly beneficial for reaching regions of the tumor that are hypoxic and difficult to treat with conventional therapies.
d) Potential for Combination Therapies: Azo-based MOFs may be designed to encapsulate multiple therapeutic agents, allowing for combination therapies that address different aspects of cancer treatment. The hypoxia-triggered release can enhance the synergistic effects of the combined drugs.

In some embodiments, a microporous photo-responsive azobenzene dicarboxylate MOF, Zr-AZB has the structure:

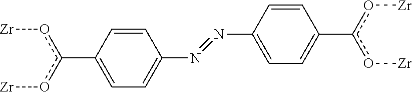

In some embodiments, the disclosure relates to how the azo bond (N═N) in the photo-responsive metal-organic framework gets cleaved under hypoxia conditions, thereby getting reduced to amino (NH₂) group. Under hypoxia conditions, azo bond reduction takes place through electron transfer mechanism in the presence of several reducing agents like NADH (nicotinamide adenine dinucleotide) or FADH2 (flavin adenine dinucleotide) in the presence of appropriate enzymes like azoreductases or NQO1. In some embodiments, the disclosure relates to the mechanism employed for these frameworks possessing azo (N═N) bond. The reducing agents donate one electron to one of the nitrogen atoms in the azo bond. This results in the formation of a radical anion intermediate. The radical anion intermediate formed undergoes protonation which leads to the formation of a hydrazo intermediate. This intermediate is highly unstable and undergoes cleavage of the azo bond to generate two separate amine radicals. The amine radicals formed rapidly react with available protons and/or other molecules in the system to form stable amine compounds. This process completes the reduction of the azo group to two amine groups. In some embodiments, the disclosure relates to how the frameworks can be utilized for cargo release under hypoxia conditions and not under normoxia conditions. In normoxia conditions, the oxygen concentration typically ranges from around 5% to 21% in the atmosphere and the pH range typically falls within a relatively narrow range to maintain homeostasis. In most cases, the pH range in biological systems is approximately 7.35 to 7.45. Cells maintain a balanced oxygen concentration suitable for normal physiological functions. So, the electrons donated by the reducing agent are accepted by oxygen rather than the azo bond of the MOF to form a superoxide anion. Whereas, in hypoxia conditions, the oxygen concentration can vary from 0.02-2% and is generally characterized by a lower pH (acidic environment). So, the tumor cells have a low oxygen and pH range which will change the action of reducing agents in the presence of enzymes. In low oxygen concentrations, one of the nitrogens of the azo bond accepts electron which leads to the formation of radical anion intermediate. The nitrogen radicals formed destabilize the azo bond, thereby promoting its cleavage. This results in the formation of two separate molecules, each containing an amine group.

In some embodiments, the azobenzene dicarboxylate MOF comprises any one of the following metal centre (M) and ligand systems (L).

| | |
|---|---|
| Metal Centre (M) | Zr(IV), Al(III), Ce(IV), Ti(IV), Fe(III), Cr(III), Ru(III), La(III), Gd(III) |
| Ligand System (L) | 1. (E)-4,4′-(diazene-1,2-diyl)dibenzoic acid |
| | 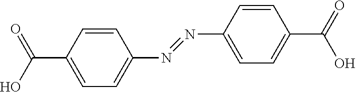 [SMILES: O=C(O)c1ccc(/N=N/c2ccc(C(=O)O)cc2)cc1] |
| | 2. 4,4′-((1E,1′E)-1,4-phenylenebis(diazene-2,1-diyl))dibenzoic acid |
| | 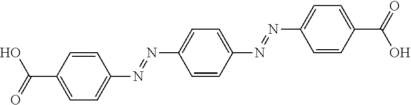 [SMILES: O=C(O)c1ccc(/N=N/c2ccc(/N=N/c3ccc(C(=O)O)cc3)cc2)cc1] |
| | 3. (E)-4-((4-carboxyphenyl)diazenyl)-1-naphthoic acid |
| | 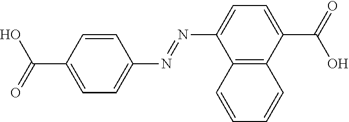 [SMILES: O=C(O)c1ccc(/N=N/c2ccc(C(=O)O)c3ccccc23)cc1] |
| | 4. (E)-4,4′-(diazene-1,2-diyl)bis(1-naphthoic acid) |
| | 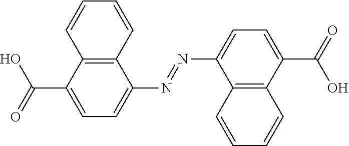 [SMILES: O=C(O)c1ccc(/N=N/c2ccc(C(=O)O)c3ccccc23)c2ccccc12] |
| | 5. (E)-4-((6-carboxynaphthalen-2-yl)diazenyl)-1-naphthoic acid |
| | 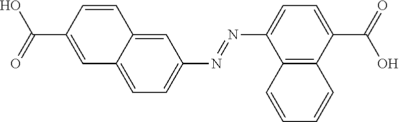 [SMILES: O=C(O)c1ccc2cc(/N=N/c3ccc(C(=O)O)c4ccccc34)ccc2c1] |
| | 6. (E)-6-((4-carboxyphenyl)diazenyl)-2-naphthoic acid |
| | 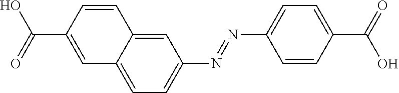 [SMILES: O=C(O)c1ccc(/N=N/c2ccc3cc(C(=O)O)ccc3c2)cc1] |
| | 7. (E)-4-((4-carboxyphenyl)diazenyl)-2-methylbenzoic acid |
| | 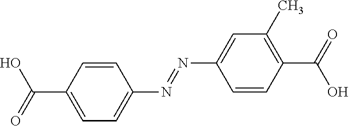 [SMILES: Cc1cc(/N=N/c2ccc(C(=O)O)cc2)ccc1C(=O)O] |
| | 8. (E)-4,4′-(diazene-1,2-diyl)bis(2-methylbenzoic acid) |
| | 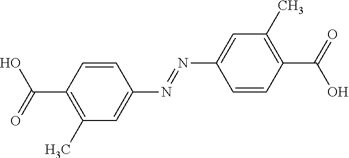 [SMILES: Cc1cc(/N=N/c2ccc(C(=O)O)c(C)c2)ccc1C(=O)O] |
| | 9. (E)-4-((4-carboxy-3-methylphenyl)diazenyl)-2,5-dimethylbenzoic acid |
| | 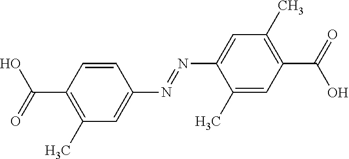 [SMILES: Cc1cc(C(=O)O)c(C)cc1/N=N/c1ccc(C(=O)O)c(C)c1] |
| | 10. (E)-4,4′-(diazene-1,2-diyl)bis(2,5-dimethylbenzoic acid) |
| | 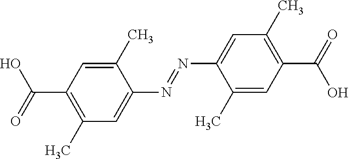 [SMILES: Cc1cc(C(=O)O)c(C)cc1/N=N/c1cc(C)c(C(=O)O)cc1C] |
| | 11. (E)-4,4′-(diazene-1,2-diyl)bis(2,3,5,6-tetramethylbenzoic acid) |
| | 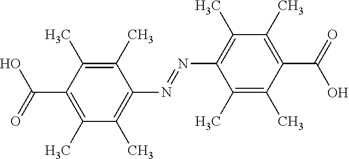 [SMILES: Cc1c(C)c(C(=O)O)c(C)c(C)c1/N=N/c1c(C)c(C)c(C(=O)O)c(C)c1C] |
| | 12. (E)-4,4′-(diazene-1,2-diyl)bis(3,5-difluorobenzoic acid) |
| | 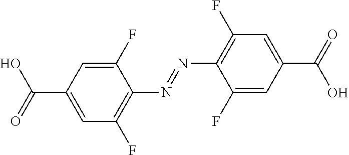 [SMILES: O=C(O)c1cc(F)c(/N=N/c2c(F)cc(C(=O)O)cc2F)c(F)c1] |
| | 13. (E)-4,4′-(diazene-1,2-diyl)bis(2,3,5,6-tetrafluorobenzoic acid) |
| | 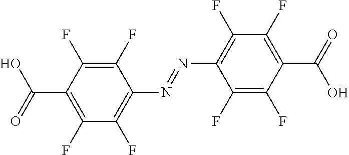 [SMILES: O=C(O)c1c(F)c(F)c(/N=N/c2c(F)c(F)c(C(=O)O)c(F)c2F)c(F)c1F] |
| | 14. 4,4′-((1E,1′E)-naphthalene-1,5-diylbis(diazene-2,1-diyl))dibenzoic acid |
| | 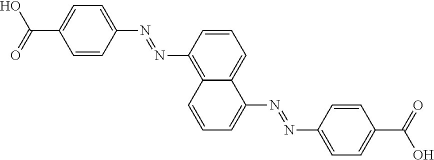 [SMILES: O=C(O)c1ccc(/N=N/c2cccc3c(/N=N/c4ccc(C(=O)O)cc4)cccc23)cc1] |
| | 15. 4,4′-(naphthalene-2,6-diylbis(diazene-2,1-diyl))dibenzoic acid |
| | 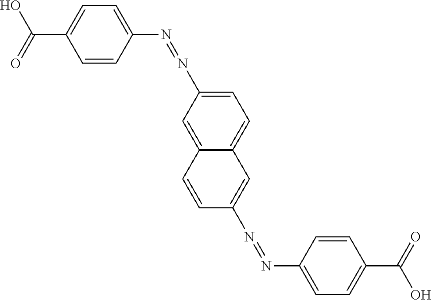 [SMILES: O=C(O)c1ccc(N=Nc2ccc3cc(N=Nc4ccc(C(=O)O)cc4)ccc3c2)cc1] |
| | 16. 4,4′-((1E,1′E)-naphthalene-2,7-diylbis(diazene-2,1-diyl))dibenzoic acid |
| | 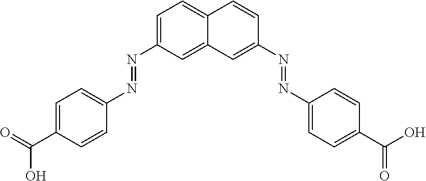 [SMILES: O=C(O)c1ccc(/N=N/c2ccc3ccc(/N=N/c4ccc(C(=O)O)cc4)cc3c2)cc1] |
| | 17. 5,5′-((1E,1′E)-naphthalene-2,7-diylbis(diazene-2,1-diyl))diisophthalic acid |
| | 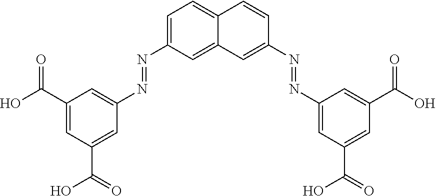 [SMILES: O=C(O)c1cc(/N=N/c2ccc3ccc(/N=N/c4cc(C(=O)O)cc(C(=O)O)c4)cc3c2)cc(C(=O)O)c1] |
| | 18. 4,4′-((1E,1′E)-1,4-phenylenebis(diazene-2,1-diyl))dibenzoic acid |
| | 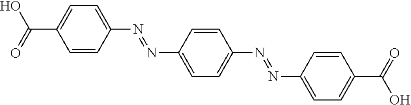 [SMILES: O=C(O)c1ccc(/N=N/c2ccc(/N=N/c3ccc(C(=O)O)cc3)cc2)cc1] |
| | 19. 4,4′-((1E,1′E)-(2,5-dimethyl-1,4-phenylene)bis(diazene-2,1-diyl))dibenzoic |
| | acid |
| | 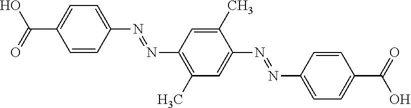 [SMILES: Cc1cc(/N=N/c2ccc(C(=O)O)cc2)c(C)cc1/N=N/c1ccc(C(=O)O)cc1] |
| | 20. 4,4′-((1E,1′E)-(2,3,5,6-tetramethyl-1,4-phenylene)bis(diazene-2,1- |
| | diyl))dibenzoic acid |
| | 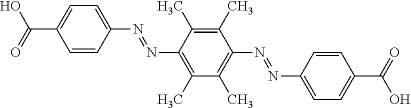 [SMILES: Cc1c(C)c(/N=N/c2ccc(C(=O)O)cc2)c(C)c(C)c1/N=N/c1ccc(C(=O)O)cc1] |

In some embodiments, the disclosure relates to how the photon-upconversion materials can be employed in drug delivery systems to achieve targeted and controlled release of therapeutic agents:
1. These materials serve as carriers for drug molecules as they can be functionalized to possess specific properties conducive to drug loading and release.
2. Upon exposure to near-infrared light (NIR), these materials trigger drug release either through encapsulating the drugs within or conjugating them to upconversion nanoparticles. Thus, NIR light can penetrate the tissues deeply, being applied externally in order to trigger the process of up-conversion and subsequently inducing drug release at the specific site.
3. The utility of NIR light for drug release offers remote control over drug delivery, allowing precise modulation of drug release kinetics.
4. Lastly, by incorporating different imaging moieties into the nanoparticles like the fluorophores, the distribution of drug-loaded nanoparticles can be easily viewed through various imaging techniques such as fluorescence imaging, providing feedback on the effectiveness of drug delivery.

In some embodiments, the spacer ligand An2Py used for the synthesis of one-dimensional coordination polymer has the structure:

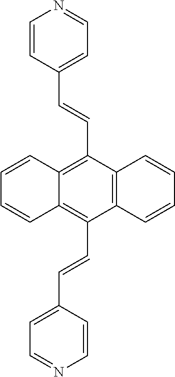 [SMILES: C(=C\c1c2ccccc2c(/C=C/c2ccncc2)c2ccccc12)/c1ccncc1]

In some embodiments, the disclosure relates to the multiphoton absorption phenomena in coordination polymers employed for cargo release under hypoxia conditions in drug delivery systems. The synthesized coordination polymers incorporate metal ions or clusters coordinated to organic ligands, having the ability to absorb multiple photons simultaneously. Different strategies like physical encapsulation, chemical conjugation and guest-host interactions can be employed by which various cargo molecules can be encapsulated or attached to the coordination polymers. In some embodiments, the disclosure relates to how the drug release process can be triggered by irradiating the multi-photon absorption (MPA)-active coordination polymer with a laser emitting photons at wavelengths corresponding to their MPA bands. The simultaneous absorption of multiple photons by the coordination polymers induces electronic transitions, generating highly localized energy, thus leading to the activation of the hypoxia-responsive release mechanism.

In some embodiments, the coordination polymer comprises any one of the following metal centre (M) and ligand systems (L).

| | |
|---|---|
| Metal Centre | Zn(II), Ag(I), Hg(II), Fe(II), Fe(III), Cu(I), Cu(II), Mn(II), Cd(II), Ni(II) |
| (M) | |
| Ligand System (L) | 1. Terephthalic acid (bdc) |
| | 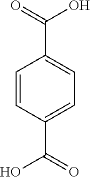 [SMILES: O=C(O)c1ccc(C(=O)O)cc1] |
| | 2. 2-aminoterephthalic acid (bdc-NH₂) |
| | 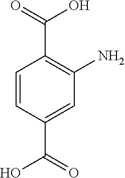 [SMILES: Nc1cc(C(=O)O)ccc1C(=O)O] |
| | 3. 2-bromoterephthalic acid (bdc-Br) |
| | 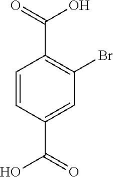 [SMILES: O=C(O)c1ccc(C(=O)O)c(Br)c1] |
| | 4. Isophthalic acid |
| | 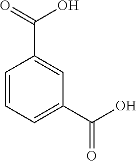 [SMILES: O=C(O)c1cccc(C(=O)O)c1] |
| | 5. Benzene-1,3,5-tricarboxylic acid (btc) |
| | 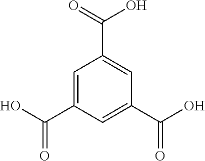 [SMILES: O=C(O)c1cc(C(=O)O)cc(C(=O)O)c1] |
| | 6. 2,5-dihydroxyterephthalic acid (bdc-(OH)₂) |
| | 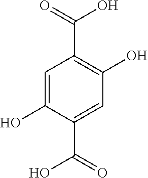 [SMILES: O=C(O)c1cc(O)c(C(=O)O)cc1O] |
| | 7. Naphthalene-2,6-dicarboxylic acid (ndc) |
| | 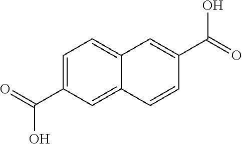 [SMILES: O=C(O)c1ccc2cc(C(=O)O)ccc2c1] |
| | 8. But-2-ynedioic acid |
| | 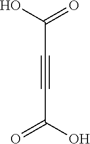 |

In some embodiments, the disclosure relates to the persistent phosphors or persistent luminescent materials emitting light long after being exposed to a light source wherein these materials can emit light for an extended period ranging from minutes to hours even when the light source is removed.

In some embodiments, the property of afterglow luminescence can be utilized for targeted drug delivery applications through:
1. Tracking and Imaging: Persistent luminescent nanoparticles can be applied as imaging agents after getting loaded with drugs and can be utilized for tracking the distribution and accumulation of drugs within the body. These nanoparticles then emit light for extended period allowing for prolonged imaging sessions without the requirement for continuous excitation.
2. Triggered Drug Release: These materials can be engineered to release drugs in response to specific stimuli like light or changes in pH and temperature. The drug release can be triggered by illuminating the particles with light of a particular wavelength after coating the drug-loaded nanoparticles with a layer of persistent luminescent material.
3. Long-Term Monitoring: These materials show advantages over the conventional imaging agents as they persist their signal upon elimination of excitation, enabling long-term monitoring of drug distribution.
4. Enhanced Penetration and Retention: Most importantly, persistent luminescent nanoparticles can overcome several drawbacks to drug delivery like poor tissue penetration and rapid clearance through the enhanced permeability and retention (EPR) effect.

In some embodiments, the disclosure relates to the photoluminescence quenching studies and in-vivo oxygen sensing of synthesized persistent materials. However, their photophysical properties have been reported but no insights have been provided on their photoluminescence behaviour in the presence of oxygen.
1. Metal-doped ZnS ceramic powders exhibiting persistent luminescence: Metal-doped ZnS ceramic powders offer versatility in terms of the dopant ions that can be incorporated and also exhibit strong luminescence making them suitable for sensing applications. The luminescent properties of metal-doped ZnS can be tailored by varying the dopant ions allowing for precise control over their sensing capabilities. These persistent luminescent materials can emit light long after the excitation source is removed. The material can store energy when exposed to light and then release it slowly over time. This persistent emission can be used to monitor changes in oxygen levels even in the absence of the excitation source, thereby enabling continuous and long-term sensing. Lastly, they also exhibit good stability and reliability as persistent oxygen sensing materials wherein they can withstand harsh operating conditions and maintain their luminescent properties over extended periods. Co³⁺ and Cu²⁺ doped ZnS nanoparticles emit visible light and shows enhanced photoluminescence emission. In doped ZnS nano crystals, impurity ion occupies the Zn lattice site and behaves as a trap site for electron and holes. The electrons are then excited from the ZnS valence band by absorbing energy equal to greater than their band gap energy.
2. Synthesis of metal-doped yttrium oxysulphide phosphors for oxygen sensing applications: Yttrium oxysulphide is a stable compound which can withstand the harsh conditions encountered in the biological system. It is non-toxic and biocompatible thereby making it suitable for in-vivo applications as it does not cause any harm or adverse reactions when in contact with living tissues. The europium dopant enhances the material's stability and luminescent properties. Europium-doped yttrium oxysulphides (Y₂O₂S:Eu) exhibit strong luminescent properties. These emit a characteristic red luminescence on excitation by an external light source wherein the intensity of this luminescence is highly sensitive to the presence of molecular oxygen, thereby making them ideal for oxygen sensing. These exhibit excellent selectivity for oxygen and do not respond to other common gases or environmental factors like pH and temperature. Hence, the selectivity ensures accurate and reliable oxygen sensing without any interference from other factors.
3. Synthesis of metal doped calcium aluminates exhibiting photoluminescence quenching in the presence of oxygen: Calcium aluminate is a stable compound which can withstand different conditions found in biological systems. It exhibits good chemical and thermal stability allowing for reliable and long-term sensing applications. Europium ions doped into calcium aluminate emit red luminescence on excitation by an external light source. The europium dopant enhances the stability and luminescent properties of the material. The luminescent properties of these materials are sensitive to oxygen concentration wherein the intensity of red luminescence decreases as the concentration of oxygen increases following a quenching effect.
4. Synthesis of persistent luminescent nano particles capable of showing enhanced photoluminescence: Near-infrared persistent luminescence nano-particles (NIR-PLNPs) can be used for in-vivo oxygen sensing applications due to the advantages of deep tissue penetration and no in-situ excitation required.

In some embodiments, the disclosure relates to how metal-organic frameworks can be utilized in optoelectronic devices such as OLEDs. MOFs exhibit different properties such as:
a) Carrier Injection and Transport: MOFs have the ability to facilitate charge injection and transport due to their intrinsic electronic properties and well-defined structures. Hence, they can be used as a host material or as a component in the emissive layer of OLEDs.
b) Emissive Materials: Most importantly, the MOFs can be functionalized with different luminescent molecules to serve as emissive materials in OLEDs. These luminescent MOFs (LMOFs) can in turn exhibit tunable emission properties including colour and intensity based on the choice of metal ions and organic linkers.
c) Enhanced Light Extraction: The porous nature of MOFs can facilitate light extraction in OLEDs by trapping and scattering light within the device structure.
d) Stability and Encapsulation: MOFs can serve as the protective layers or encapsulants for OLED devices, offering improved stability against environmental factors like moisture and oxygen. The device's lifetime and reliability get increased on coating OLEDs with MOF thin films, thus making them suitable for various applications like displays and lighting.
e) Hybrid Structures: MOFs can be combined with other functional materials like polymers or quantum dots to create novel OLED architectures. These hybrid systems can synergistically combine the unique properties of MOFs with those of other materials, resulting in enhanced device performance and functionality.

In some embodiments, the disclosure relates to MOFs offering numerous advantages and exhibiting unique properties making them well-suited for OLEDs as compared to the existing ones:
a) Versatile Chemistry: A wide range of metal ions and organic ligands can be utilized for synthesizing MOFs, thereby offering flexibility in tailoring both electronic and optical properties. These materials can be further modified with desirable luminescent characteristics like colour tunability and high photoluminescence quantum yields.
b) Tailorable Structure and Pore Size: The versatile nature of MOFs with tunable structures pore sizes makes them suitable materials for OLED applications as these can efficiently control the transport of charge carriers and optimize light emission properties.
c) High Surface Area: MOFs exhibit high surface area, thereby enhancing the interaction between the emissive materials and charge carriers within the OLED device. This results in improved charge injection, transport and recombination, which finally results in enhanced device efficiency and performance.
d) Gas Adsorption Capabilities: MOFs adsorb and desorb small molecules, which help in mitigating issues like quenching of luminescent species or degradation of OLED materials due to exposure to environmental contaminants.
e) Potential for Hybrid Systems: Multifunctional OLED devices can be created by integrating MOFs into hybrid structures like organic semiconductors or quantum dots which exhibit synergistic effects, resulting in improved device performance and functionality.
f) Environmental Sustainability: Most of the MOFs consist of abundant and environment friendly elements, which makes them ideal candidates for sustainable optoelectronic applications. The tunable properties of MOFs enable the design of more energy-efficient OLED devices, which in turn results to environmental sustainability.

In some embodiments, the disclosure shows few supports that MOFs can be employed for uses in OLEDs or similar electronic applications:

| SNo. | MOF | Absorption | Emission | DOI |
|---|---|---|---|---|
| 1. | Zr-NDC | 350 nm | 425 nm | https://doi.org/10.1002/adom.201701060 |
| | NDC = dimethyl 2,6- | | | |
| | naphthalenedicarboxylate | | | |
| 2. | Zr-NBP | 263, 366 | 490/536 | https://doi.org/10.1002/anie.202117608 |
| | triarylamine-based ligand | nm | | |
| | and | 285 nm | 390/401 | |
| | Zr-MTB triarylamine- | | | |
| | based ligand | | | |

In some embodiments, the disclosure relates to how MOFs have gained significant attraction in the field of photovoltaics due to their unique properties:
a) Light Harvesting: MOFs can be designed to encapsulate the light-absorbing chromophores or metal centres capable of harvesting photons across a wide range of the spectrum.
b) Charge Separation and Transport: Due to the presence of well-defined pore structures and tunable electronic properties, MOFs facilitate the separation and transport of photogenerated charge carriers. It is possible to control the composition and structure of MOFs and in turn the energetics and mobility of charge carriers can be tailored resulting in enhanced charge transport and reduced recombination losses.
c) Interfaces with Electron and Hole Transport Layers: In photovoltaic devices, MOFs serve as interfaces between the active layer and hole or electron transport layers. These interfaces help in improving the charge extraction, reducing charge carrier recombination and enhancing device performance by facilitating efficient charge transfer at the heterojunction interfaces.
d) Tandem and Multi-Junction Devices: The absorption spectrum can be broadened and power conversion efficiency can be increased by integrating MOFs into multi-junction photovoltaic devices.
e) Stability and Encapsulation: By coating the active layer with MOF thin films, it is possible to mitigate the degradation mechanisms caused by exposure to moisture, oxygen or environmental factors resulting in improved device reliability and operational lifetime. Hence, MOFs can be used as protective coatings or encapsulants for photovoltaic devices to enhance their stability and longevity.

In some embodiments, the disclosure relates to MOFs offering several advantages and value propositions when employed for photovoltaic applications, which in-turn significantly impacts the market in the following ways:
a) Enhanced Efficiency: Efficiency gets improved in terms of better light absorption, charge separation and transport when MOFs are being incorporated into photovoltaic devices. It is easier to tailor MOFs in order to harvest photons across a broader spectrum, optimize charge carrier dynamics and minimize losses due to recombination, thereby enhancing the overall power conversion efficiency of photovoltaic devices.
b) Improved Stability and Reliability: By mitigating degradation mechanisms, MOFs can prolong device's lifetime and minimize maintenance costs, resulting in improved long-term performance and market competitiveness. This is possible as MOFs synthesized can be used as encapsulants for photovoltaic devices, thereby offering enhanced stability and reliability against environmental factors like oxygen, moisture and UV radiation.
c) Broadened Material Portfolio: Novel materials like MOFs with tunable structures and exhibiting tailored electronic and optical properties, allows for greater flexibility in device optimization and performance enhancement. Thus, these porous materials expand the material portfolio for photovoltaic device design.
d) Stability and Cost-Effectiveness: Cheap and abundant precursors are employed for MOF synthesis which lowers both the production costs and the overall cost per watt of solar energy generated. This makes them suitable for large-scale production of photovoltaic materials.
e) Sustainability and Environmental Benefits: Several green chemistry techniques can be utilized for MOF synthesis consisting of environmentally friendly elements. MOFs contribute to the transition towards cleaner and more environmentally responsible energy sources, aligning with market demands for renewable energy solutions with minimal environmental impact.

### EXAMPLES

### 1. General Experiments

All the experiments in this example were carried out under normal atmospheric conditions, except in any case demonstrated. Most of the reagents were commercially available and used directly without further purification. ¹H NMR spectra were recorded on a Bruker NMR 500 DRX spectrometer at 500 MHz and referenced to the proton resonance resulting from deuterated chloroform (δ 7.26). Room temperature powder X-ray diffraction data were collected on a Bruker Advance diffractometer using Ni-filtered Cu Kα radiation (λ=1.5406 Å). Data were collected with a step size of 0.05° and at count time of 1 s per step over the range 4°<2θ<70°. High-resolution mass spectra (HRMS) were recorded on a Q-TOF Bruker instrument, using electrospray ionization (ESI) as the ionization method. Infra-Red (IR) spectra of samples were recorded with FT-IR Spectrometer (MS-632). KBr pellets of powder samples were made after vacuum drying at 100° C. in order to remove the moisture. Thermogravimetric analysis (TGA) was performed under the nitrogen gas environment using a Simultaneous thermal analyzer (STA 6000 from Perkin Elmer, USA). The weight of the empty pan was used as a reference. The samples (˜weight of 10-15 mg) were completely dried before analysis and were heated from 20° C. to 950° C. at a scanning rate of 40° C./min. The morphology and chemical compositions were analysed with a Ziess TEM operating at 120 KV. For analysis, MOFs were briefly sonicated in methanol solution and drop-casted onto carbon copper grids. The average particle size was calculated using Origin software considering at least 20 different images and at least 30 particles per image. MOF samples were vacuum dried at room temperature, and then these were measured under ultra-high vacuum environment. Surface area and pore volume were measured using a BELLSORP MAZ II-high performance gas and vapor adsorption system with three microporous ports. For BET surface area measurements, MOF samples were initially dried via freeze drying method, wherein, the MOF sample was first soaked with benzene. Then, the MOF slurry was freezed at 0° C. and then slowly dried under vacuum at the same temperature. This was followed by degassing of the samples under vacuum at 80° C. for 24 h before measurement. Freeze drying method was employed for MOF samples in order to carry out their bio-stability tests. For BET analysis, MOFs were kept in a vacuum at 70° C. for two hours and, after mass measurement, the tubes were attached to the instrument. The porosity of the samples was characterized by N₂ sorption at −196° C. Pore volume (Vp) was estimated with discrete Fourier transform (DFT) calculations from the N₂ sorption isotherm. Porosity was calculated using the following formula—

$$P = \frac{{V}_{p}}{{V}_{p} + \frac{1}{{ρ}_{Si}}} , where {ρ}_{S i} = 2.33 g / {cm}^{3} .$$

### 2. Synthesis

2.1 Synthesis of Z1, (E)-4,4′-(diazene-1,2-diyl)dibenzoic Acid

p-Nitrobenzoic acid (1 g, 5.98 mmol) and NaOH (3.35 g, 83.75 mmol) were added in 15 mL of distilled water to a round bottom flask. The solution was then heated to 50° C. and stirred until the solid was dissolved. In a 50 mL beaker, glucose (6.625 g, 36.77 mmol) was dissolved in 10 mL distilled water and sonicated for some time and was added dropwise to the above mixture, which then slowly turned yellow followed by brown upon the addition of glucose solution. The reaction took place at 80° C. for 12 h in the open atmosphere. By centrifuging, the brown product was separated. After the product was air dried, distilled water was added to dissolve it. A pink precipitate appeared upon the addition of 5 mL of acetic acid to acidify it. The product was isolated and washed three times with distilled water by centrifugation. The desired product was obtained after drying.

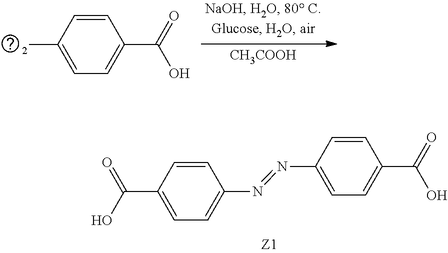

2.2 Synthesis of Z2, 9,10-bis((E)-2-(pyridine-4-yl)anthracene)

In a schlenk flask, 4-Vinyl-pyridine (1 g, 9.51 mmol) and 9,10-dibromoanthracene (1.4 g, 3.97 mmol) were dissolved in 30 mL of DMF. K₂CO₃ (2 g, 14.5 mmol) and then PdCl₂ (5 mg) were added to it. N2 was bubbled into the mixture for 15 minutes, and the mixture was refluxed at 140° C. under N2 atmosphere. After 15 h, the reaction mixture was cooled to room temperature and 100 mL of distilled water was added to it. The crude solid was obtained by filtration. The orange product was obtained by column chromatography (silica, CH₂Cl₂/ethyl acetate=¼).

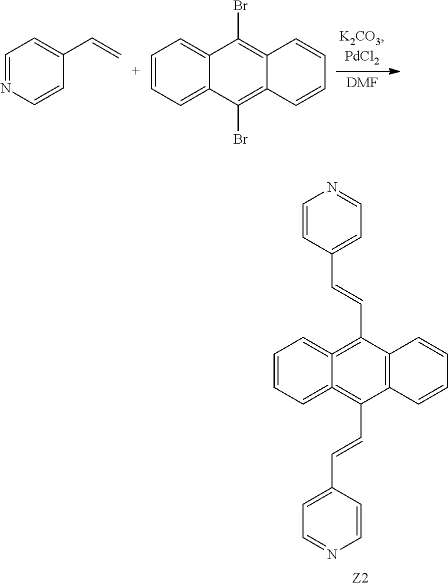

### 2.3 Synthesis of Y1, Zr-AZB MOF

In a 15 mL vial, zirconium tetrachloride (10 mg, 0.0429 mmol) was dissolved in 4.3 mL DMF, and 0.3 mL HCl was added dropwise. In a 25 mL round bottom flask, (E)-4,4′-(diazene-1,2-diyl)dibenzoic acid (Z1) (17.5 mg, 0.0715 mmol) was dissolved in 4.3 mL DMF and was heated at 80° C. until it was fully dissolved. The two solutions were then mixed in a 15 mL vial and placed at 100° C. for 5 days. The orange crystalline product was obtained. After cooling to room temperature, the product was washed with DMF followed by three times with methanol, and isolated by centrifugation.

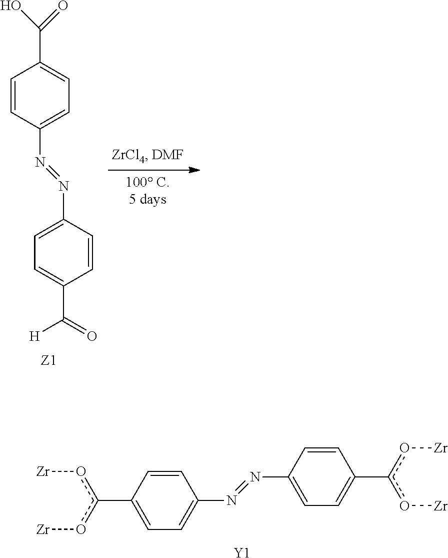

2.4 Synthesis of Y2, [Zn₂(benzoate)₄(An2Py)₂] Coordination Polymer

Zn(NO₃)₂·6H₂O (14.9 mg, 0.05 mmol) in 1 mL of methanol was layered over 9,10-bis((E)-2-(pyridine-4-yl)anthracene) (Z2) (19.2 mg, 0.05 mmol) in 2.5 mL of THF and sodium benzoate (14.4 mg, 0.1 mmol) in 1 mL water with acetonitrile as middle buffer layer. Orange plate-like crystals were obtained. The crystals were then washed three times with THF followed by centrifugation.

### 3. Infra-Red (IR) Spectra Analysis

The stretching frequency values of different involved functional groups were determined by plotting the FTIR spectra of Z1 linker and Y1 MOF.

TABLE I
Stretching frequency data for Z1 linker and Y1 MOF

| | Z1 linker (cm⁻¹) | Y1 MOF (cm⁻¹) |
|---|---|---|
| ν(OH) | 2300-3300 | — |
| ν(C═O) | 1690 | 1600 |
| ν(N═N) | 1425 | 1415 |

TABLE II
Stretching frequency data for Y1 MOF in acidic medium

| | pH-1 (cm⁻¹) | pH-3 (cm⁻¹) | pH-5 (cm⁻¹) |
|---|---|---|---|
| ν(OH) | 3310 | 3310 | 3300 |
| ν(C═O) | 1690 | 1650 | 1650 |
| ν(N═N) | 1420 | 1420 | 1420 |

TABLE III
Stretching frequency data for Y1
MOF in aqueous and alkaline media

| | pH-7 (cm⁻¹) | pH-9 (cm⁻¹) | pH-11 (cm⁻¹) |
|---|---|---|---|
| ν(OH) | 3335 | 3330 | 3335 |
| ν(C═O) | 1600 | 1600 | 1600 |
| ν(N═N) | 1420 | 1420 | 1400 |

### 4. Quantum Yield Measurements

The quantum yield measurements were done using the integrating sphere method. The quantum yield value of the synthesized Y2, [Zn₂(benzoate)₄(An2Py)₂] coordination polymer was determined in DCM solvent.
Quantum yield=43.00% for Y2 coordination polymer

### EQUIVALENTS AND SCOPE

While several embodiments of the present disclosure have been described and illustrated herein, those of ordinary skill in the art will readily envision a variety of other means and/or structures for performing the functions and/or obtaining the results and/or one or more of the advantages described herein, and each of such variations and/or modifications is deemed to be within the scope of the present disclosure. More generally, those skilled in the art will readily appreciate that all parameters, dimensions, materials, and configurations described herein are meant to be exemplary and that the actual parameters, dimensions, materials, and/or configurations will depend upon the specific application or applications for which the teachings of the present disclosure is/are used. Those skilled in the art will recognize, or be able to ascertain using no more than routine experimentation, many equivalents to the specific embodiments of the disclosure described herein. It is, therefore, to be understood that the foregoing embodiments are presented by way of example only and that, within the scope of the appended claims and equivalents thereto, the disclosure may be practiced otherwise than as specifically described and claimed. The present disclosure is directed to each individual feature, system, article, material, kit, and/or method described herein. In addition, any combination of two or more such features, systems, articles, materials, kits, and/or methods, if such features, systems, articles, materials, kits, and/or methods are not mutually inconsistent, is included within the scope of the present disclosure.

In cases where the present specification and a document incorporated by reference include conflicting and/or inconsistent disclosure, the present specification shall control. If two or more documents incorporated by reference include conflicting and/or inconsistent disclosure with respect to each other, then the document having the later effective date shall control.

All definitions, as defined and used herein, should be understood to control over dictionary definitions, definitions in documents incorporated by reference, and/or ordinary meanings of the defined terms.

The indefinite articles “a” and “an,” as used herein in the specification and in the claims, unless clearly indicated to the contrary, should be understood to mean “at least one.”

The phrase “and/or,” as used herein in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified.

As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used herein shall only be interpreted as indicating exclusive alternatives (i.e. “one or the other but not both”) when preceded by terms of exclusivity, such as “either,” “one of,” “only one of,” or “exactly one of.”

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. When the word “about” is used herein in reference to a number, it should be understood that still another embodiment of the disclosure includes that number not modified by the presence of the word “about.”

It should also be understood that, unless clearly indicated to the contrary, in any methods claimed herein that include more than one step or act, the order of the steps or acts of the method is not necessarily limited to the order in which the steps or acts of the method are recited.

In the claims, as well as in the specification above, all transitional phrases such as “comprising,” “including,” “carrying,” “having,” “containing,” “involving,” “holding,” “composed of,” and the like are to be understood to be open-ended, i.e., to mean including but not limited to. Only the transitional phrases “consisting of” and “consisting essentially of” shall be closed or semi-closed transitional phrases, respectively, as set forth in the United States Patent Office Manual of Patent Examining Procedures, Section 2111.03.

What is claimed is:

1. A metal-organic framework (MOF), comprising:
[M-AZB]
wherein:
M is Zr(IV), Al(III), Ti(IV), Fe(III), Ce(IV), Cr(III), Ru(III), La(III), Gd(III); and
AZB is Azobenzene dicarboxylate ligand.

2. The MOF of claim 1, wherein the AZB ligand comprises a structure:

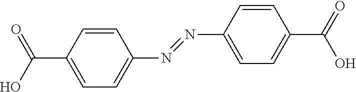 [SMILES: O=C(O)c1ccc(/N=N/c2ccc(C(=O)O)cc2)cc1]

3. The MOF of claim 2, wherein the AZB ligand has the formula AZB(COOH)₂.

4. The MOF of claim 1, wherein the AZB ligand comprises a structure:

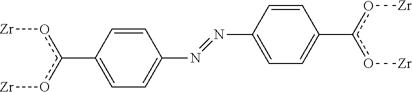

5. The MOF of claim 3, wherein the MOF is stable in PBS (1x) solvent.

6. The MOF of claim 3, wherein the azo bond (N═N) gets reduced to amine (NH₂) group under hypoxic conditions.

7. The MOF of claim 3, wherein the MOF under hypoxic conditions forms a radical anion intermediate after accepting the electrons from reducing agent.

8. The MOF of claim 3, wherein the MOF retains crystallinity under aqueous medium conditions and shows stability at pH 7 conditions.

9. The MOF in claim 3, wherein the MOF shows Nitrogen adsorption and desorption isotherm at 77.360 K and wherein the BET surface area is measured to be 83.028 m²/g.

10. The MOF in claim 3, wherein the MOF shows spherical morphology and wherein the average size of the MOF is 100±20nm.

11. A coordination polymer of formula (IV): 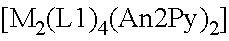
wherein:
M is Zn(II), Ag(I), Fe(II), Fe(III), Cu(I), Cu(II), Mn(II), Cd(II), Ni(II) etc.;
L1 is benzoate ligand;
An2Py is 9,10-bis((E)-2-(pyridine-4-yl)anthracene).

12. The coordination polymer of claim 11, wherein the spacer ligand An2Py has the structure:

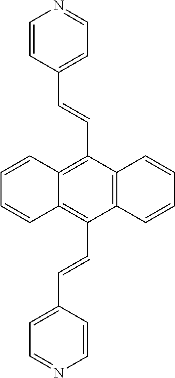 [SMILES: C(=C\c1c2ccccc2c(/C=C/c2ccncc2)c2ccccc12)/c1ccncc1]

13. The coordination polymer of claim 11, wherein the coordination polymer has a symmetrical acceptor-II-donor-II-acceptor structure.

14. The coordination polymer of claim 11, wherein the coordination polymer has a one-dimensional coordination polymer exhibiting multi-photon absorption.

15. The coordination polymer of claim 11, wherein the coordination polymer exhibits frequency up-conversion via multiphoton excitation at wavelengths ranging from 800-1500 nm.

16. The coordination polymer of claim 11, wherein the coordination polymer has one-photon absorption at an excitation wavelength of 467 nm.

17. The coordination polymer of claim 11, wherein the coordination polymer shows an emission spectrum at 570 nm.

18. The coordination polymer of claim 11, wherein the coordination polymer exhibits both two-photon and three-photon absorption spectra.

19. The coordination polymer of claim 11, wherein the coordination polymer has a quantum yield of 43%.

20. A composition comprising a coordination polymer comprising a plurality of metal clusters and a plurality of ligands coordinating with the plurality of metal clusters, wherein at least one metal cluster comprises a metal ion, and wherein the plurality of ligands comprises 9,10-bis((E)-2-(pyridine-4-yl)anthracene ligand.
